(19) United States
(12) Patent Application Publication
(10) Pub. No.: US 2016/0267083 A1
(43) Pub. Date: Sep. 15, 2016

(54) REAL TIME INFORMATION RETRIEVAL OF QURANIC CITATIONS AND EXPLANATIONS OF THE QURAN (TAFSEER-UL-QURAN) IN THE NATIVE LANGUAGE OF THE USER

(71) Applicant: Umm Al-Qura University, Makkah (SA)

(72) Inventors: Noman Ahmed Shah, Makkah (SA); Imran Ahmed Shah, Lahore (PK); Kamran Ahmed Shah, Leeds (GB)

(21) Appl. No.: 14/645,749

(22) Filed: Mar. 12, 2015

(51) Int. Cl. G06F 17/30; G06K 9/00; G06T 19/00; G06K 9/34; G06K 9/46; G06K 9/80; G06K 9/62; G06K 9/18

(52) U.S. Cl. CPC G06F 17/30017; G06K 9/6297; G06K 9/00442; G06K 9/00879; G06K 9/18; G06K 9/344; G06K 9/46; G06K 9/4642; G06K 9/80; G06T 19/006; G06F 17/30684; G06F 17/30672; G06F 17/30663; G06F 17/30867; G06K 2009/00489; G06K 2209/013

(57) ABSTRACT

A method and system for real time informational and augmented reality representation of the Quranic Citations and native language explanations of the Holy Quran (Tafseer-ul-Quran) corresponding to an image of the Arabic script includes a programmable computer having memory and a copy of the Holy Quran in Arabic script as well as explanations of the Holy Quran (Tafseer-ul-Quran) in said memory and a native language of the Holy Quran and explanation of the Holy Quran (Tafseer-ul-Quran) in a native language. The system and method includes or provides a device for inputting queries re: the Holy Quran to the programmable computer after receiving and displaying responses from the computer. The computer takes real-time images, segregates manuscript and detects the native language of the user. Then the computer initiates search queries and communications with the user device and ultimately displays certified information as augmented reality.

### FIELD OF THE INVENTION

This invention relates to real time information retrieval of Quranic citations and explanations of the Holy Quran (Tafseer-ul-Quran) in the native language of the user and more particularly to an augmented reality representation and real time information retrieval of Quranic citations and explanations of the Holy Quran (Tafseer-ul-Quran) in the native language of the user corresponding to an image of the Arabic script.

### BACKGROUND OF THE INVENTION

The Holy Quran is the central religious text of Islam containing revelations of Allah (God) as revealed to Prophet Hazrat Muhammad (peace be upon him, SAW). The Holy Quran is partitioned into thirty (30) even parts called “juz-un” in Arabic or Para in Farsi/Persian. The Holy Quran is comprised of 114 Sura'ht of unequal length and each Sura'ht is numbered and displayed with a title. There are a total of about 6,327 Aya'hts in the Holy Quran. The term Ayaht-e-Karmiah refers to verses in the Holy Quran.

In addition to the above, Hadith is a saying of the Prophet Muhammad (peace be upon him, SAW). Other terms such as Tafseer (Tafseer-ul-Quran) refer to the interpretations of the Holy Quran based on the knowledge about the Holy Quran and Hadith. Tashreh (Tashreh-ul-Quran) refers to the further interpretation of the Holy Quran, Quranic verses and terms while Diacritics refer to Quranic Arabic i.e. the traditional Arabic grammar as used to visualize Quranic syntax and to provide guidelines for a reader to pronounce.

A U.S. Patent Publication No. 2011/0143325 of Awad H. Al-Khalaf and Anas L. Nayfeh discloses an Automatic Integrity Checking of Quran Script. As disclosed therein the aforementioned publication allows for people to check the correctness of the printed verses against the authentic version of the Holy Quran. It also provides the ability to check the Holy Quran's verses written in the scientific papers and in web pages. Using the mechanism this invention will help in protecting the Holy Quran from any distortion. This is important because of the following:
1. The Internet became very wide and many sites are citing Quran verses. Sometimes the used verses contain some intentional or unintentional mistakes. Many of the Internet users do not notice these mistakes.
2. The increasing number of Muslims as well as the people who are joining Islam, many of them do not speak Arabic.
3. The need to print and distribute many copies of the Quran all over the world after correcting textual and typographical errors comparing with authenticated copy. This task requires time, effort and expert people on the Holy Quran.

A more recent U.S. Pat. No. 8,150,160 of Husni A. Al-Muhtaseb, Sabri A. Mahmoud and Rami Qahwaji disclose an Automatic Arabic Text Image Optical Character Recognition Method. As disclosed the method includes training a text recognition system using Arabic printed text, using the produced models for classification of newly unseen Arabic scanned text, and generating the corresponding textual information. Scanned images of Arabic text and copies of minimal Arabic text are used in the training sessions. Each page is segmented into lines. Features of each line are extracted and input to Hidden Markov Model (HMM). All training data and training features are used. HMM runs training algorithms to produce codebook and language models. In the classification stage new Arabic text is input in scanned form. Line segmentation where lines are extracted is passed through. In the feature stage, line features are extracted and input to the classification stage. In the classification stage the corresponding Arabic text is generated.

Further a U.S. Patent Publication No. 2003/0200078 of Luo et al. discloses a System and Method for Language Translation of Character Strings Occurring in Captured Image Data. The aforementioned publication discloses a system and method capable of performing language translation of a graphical representation of a first language character string within captured image data of a natural image by extracting image data corresponding to the graphical representation of the text from the captured image data. The extracted graphical representation is then converted into a first language encoded character data that, in turn, is translated into a second language data. The translated text and the captured image can then be displayed together by overlaying the translated text over the graphical representation of the character string in the captured image.

Notwithstanding the above, it is presently believed that there is a current need and a potential commercial market for a real time information retrieval of Quranic Citations and explanations of the Holy Quran (Tafseer-ul-Quran) in the native language(s) of the readers (user). There should be a need and a commercial market because the method and system in accordance with the present invention provide immediate access to real time interpretation and explanation of the Holy Quran in the user's native language explained by the authenticated scholars of Islam. The system is available over a handheld device, smartphone or the like or accessed through a network.

### BRIEF SUMMARY OF THE INVENTION

In essence, a system for real time information and augmented reality representations of the Quranic Citations and explanations of the Holy Quran (Tafseer-ul-Quran) in the native language of the user corresponding to an image of the Arabic script will be available. The system comprises or consists of a programmable computer having memory and a copy of the Holy Quran in Arabic script and an explanation of the Holy Quran (Tafseer-ul-Quran) in memory, and translation of the Holy Quran in native language(s) from the Arabic and explanation of the Holy Quran (Tafseer-ul-Quran) in the native language of the user. The system further comprises or consists of a device for inputting queries re: the Holy Quran to said programmable computer for receiving and displaying responses from the computer on the device preferably a remote device. Further, the programmable computer performs operations of taking real time images and inputs through a user interface and segregating a manuscript from images and detecting language of manuscript characters and marking the manuscript characters differentiating by language(s) and having at least one block marked as Arabic language script and detecting the native language of the user. The system or method further comprises or consists of initiating separate search queries using text of each manuscript block as a query term to locate the manuscript text blocks from interlink internal and external data storage. Further, the system communicates with the user device with certified information for each segregated block and a further step of displaying the certified information as augmented reality on the user's device.

The invention will now be described in connection with the accompanying drawing.

### DESCRIPTION OF THE DRAWINGS

FIG. 1 is a flowchart illustrating the steps in a system and/or method for practicing the invention.

### DESCRIPTION OF THE PREFERRED EMBODIMENT OF THE INVENTION

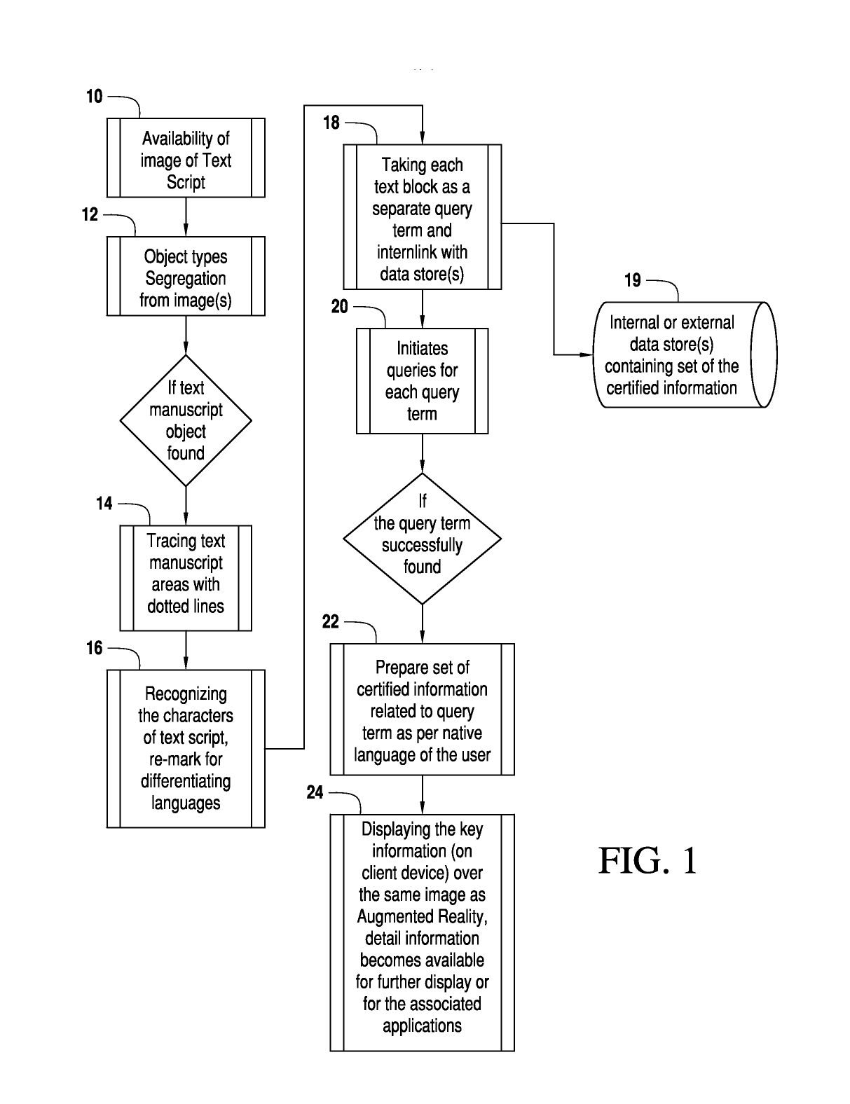

As illustrated in FIG. 1, a system, method, apparatus according to the present invention includes a computer and program products operable to perform operations on an image containing textual elements.

In a first step 10 an image containing textual elements is scanned into the computer and stored in memory. The image is taken in real time via an internal or external input device (including an image scanning interface or camera) or being accessed from an internal or external memory.

If the real-time image is taken from an interface, an autofocus procedure may be initiated including adjustment to aperture, zoom, brightness, sharpness of resolution to form a properly focused real-time image for better visibility and readability and for recognizing textual elements with the best possible accuracy.

In a second step 12, the types of the objects are segregated from images and areas recognized as manuscript are tracked for a next step. In a third step 14, text manuscript areas, regions are marked with dotted lines.

As a fourth step 16, the character of the text manuscript are recognized and the language of each text manuscript block is identified, and each area of text manuscript is re-marked differentiating the languages of the text manuscript areas. In step 16 there are two activities, first activity is to identify the language(s) of the manuscript and based on the result of language identification, in second activity each area of the different language text is re-marked with different marks. In a fifth step 18, each text block is taken as a separate query term and interlinked with internal and/or external data stores corresponding to the language of the text block.

A sixth step 20, involves initiating separate search queries for each query term to locate the query term values in interlinked data storage. The sixth step 20 is followed by a seventh step 22 wherein a search query successfully finds the query term(s) in the stored records. Thus, each record contains a set of certified information (including certified citation, certified key references, original references with human translations, cross references and definitions with human translations, described, explainrd in different native languages in basic format like text, audio and video) corresponding to related text (used as query term) becomes accessible. Further, this step selects the citation references available in the native language of the client and returns the information to the user's device in real-time environment.

Finally, in an eighth step 24 the key information is displayed on the user's device over the same image as augmented reality representation and detail information becomes available for further display on the same image or for associated applications (where text matters are displayed by default text viewer, reading and explanations available in audio are playable with default audio player and similarly explanations and interpretations available in video format are playable and video streaming through default audio/video player. Set of certified information found in seventh step 22 are also available for third party applications such as text editors or worksheet editors to facilitate the users (as per user needs).

As an example of the practice of the invention consider the following.

In a case (one embodiment) of an Arabic language manuscript, the best utilization of the system is information retrieval related to the Holy Quran (religious book of Muslims) from the certified data store containing the key references citation (Para Number, Ruku Number, Manzil/Sur'ht and Ayaht Number/Label or Number), original references (Ayaht-e-karmiah and Sur'ht) and human translations, cross references (e.g. Hadith), definitions/explanations (Tafseer-ul-Quran, Tashreh-ul-Quran and Tashreh-ul-Hadith) human translated and/or described in different local & native languages in the basic formats like text, audio and video by the certified experts of Holy Quran & Hadith and/or Islamic Scholars. The set of key information will be displayed on the display of client device along with the actual text manuscript (over the same image) while user or other applications of the client device will be able to access further information through the related icons, symbols indicating or marked along with the key information displayed.

The following illustrates a further embodiment of the invention.
1. client has chosen Urdu Language for output information, or the system detected Urdu Language as the native language of the user (of the device) from default user interface settings, and at least one block of text manuscript is identified (in step 16) as an Arabic language text, a data store 19 containing a copy of Holy Quran and Quranic Citation with the interlinked in step 18 for search query,
2. and if a text of a Arabic manuscript area is found successfully in the data store 19 as a portion of a Quranic Verses (Ayaht of Holy Quran).
3. Key Reference(s), Quranic Citation; (the references about Ayaht number, Sura'ht number and Parah number) will be displayed on same image alongside of manuscript area
4. Original Reference(s), actual Ayaht-e-karimah in Arabic will be displayed in next section,
5. then in next section, the translation of this Ayaht in Urdu language will appear
6. In next portion a definition/Tafseer-ul-Quran/Tashreh-ul-Quran will also appear in Urdu language
7. Recite of Holy Quran will also be available, an icon will also appear to start reading (Talawat of Ayaht) or repeat,
8. If the translation in Urdu is available as recorded audio, an icon will also appear to re-play
9. If the Tafseer-ul-Quran is available in Urdu as recorded audio, an icon will also appear to re-play
10. Similarly, the icons for replay the video files of Recite of Holy Quran by a Qari (speaker), its icon will also appear.
11. If the translation reading in Urdu is available as recorded video file, an icon will also appear to re-play (with default associated application for video playback or streaming),
12. If the Tafseer-ul-Quran reading is available in Urdu as recorded video file, an icon will also appear to re-play
13. Another icon may appear to open the web reference for same set of information to open in the default web browser of the client device.

The following glossary of terms are applicable to the present invention.
Holy Quran: Holy Book of Islam (in Arabic Language)
Para: Quran is separated into thirty (30) even parts called “juz-un” in Arabic or Para in Persian (Farsi/Persian).
Ruku: Ar-Rukû': in the Indian sub-continent's Mushafs the Sura'hts of the Glorious Qur'an are divided into parts called “Ruku'ât”. The Rukâ' is a number of verses recommended for reading in each Rak'ah of Prayer. The sign for Rukû' is the letter 'Ain ( [symbol] ) placed on the right and left margins of the Mushaf.
Manzil: Al-Manzil: in the Indian sub-continent the Holy Qur'an is partitioned into seven parts almost equal in length. Each part is called Manzil. Following are the beginning of the seven Manzils:
   1. The beginning of Sura'ht Al-Fatihah
   2. The beginning of Sura'ht Al-Ma'idah
   3. The beginning of Sura'ht Yunus
   4. The beginning of Sura'ht Al-Israâ'
   5. The beginning of Sura'ht Ash-Shu'arâ'
   6. The beginning of Sura'ht As-Saffât
   7. The beginning of Sura'ht Qâf
Surat/Sura'ht: A chapter in the Quran. Quran is comprised of 114 sura'hts of unequal size. Surahs (chapters) are numbered and consecutive numbers are displayed along with the title of each sura'ht.
Ayah/Ayaht: An individual verse in the Quran. there are a total of about 6,327 ayahts in the entire Quran
Ayaht-e-karmiah: Verses in the Quran.
Hadith: sayings of the Prophet Hazrat Muhammad (S.A.W.).
Tafseer-ul-Quran: The interpretation of Quran based on the knowledge about Quran and Hadith (Tafseer-ul-Quran)
Tashreh-ul-Quran: The interpretation of Quran, Quranic Verses and terms.
Diacritics: In the Quranic Arabic Corpus, the traditional Arabic grammar of i'rāb ( [symbol] ) is used to visualize Quranic syntax

While the invention has been described in connection with the preferred embodiments it should be recognized that changes and modifications may be made therein without departing from the scope of the appended claims.

What is claimed is:

1. A system for real time informational and augmented reality representation of the Quranic Citations and explanations of the Holy Quran (Tafseer-ul-Quran) in the native language of the user corresponding to an image of Arabic script, said system comprising:
a programmable computer having memory and an image of the Arabic script and a copy of the Holy Quran in Arabic script and an explanation of the Holy Quran (Tafseer-ul-Quran) in said memory, and a native language translation of the Holy Quran and explanation of the Holy Quran (Tafseer-ul-Quran) in the native language of the user in said memory;
a device for inputting queries re: the Holy Quran to said programmable computer for receiving and displaying responses from said computer on said device;
said programmable computer performing operations of taking real time images and inputs through a user interface and segregating manuscript from images and marking manuscript characters and detecting native language of the user from default setting of the user interface;
initiating separate search queries using the text of each manuscript block as a separate query term to locate the blocks from interlinked internal and external data storage having certified information, references and explanations described in different native languages;
communicating with said user device with certified information in each segregated block; and
displaying the certified information as augmented reality.

2. The real time information retrieval and augmented reality representation of the Quranic Citations and explanations of the Holy Quran (Tafseer-ul-Quran) in the native language of the user corresponding to an image of Arabic script system according to claim 1, which includes a real time image scanning interface or being accessed from an internal or external storage.

3. The real time information retrieval and augmented reality representation of the Quranic Citations and explanations of the Holy Quran (Tafseer-ul-Quran) in the native language of the user corresponding to an image of Arabic script system according to claim 2, which includes an auto focus procedure including adjustment to aperture, zoom, brightness, contrast and resolution to focus on real time image for better visibility, readability and best possible accuracy.

4. The real time information retrieval and augmented reality representation of the Quranic Citations and explanations of the Holy Quran (Tafseer-ul-Quran) in the native language of the user corresponding to an image of Arabic script system according to claim 3, in which the language of the each text manuscript region is identified and marked to differentiate its language.

5. The real time information retrieval and augmented reality representation of the Quranic Citations and explanations of the Holy Quran (Tafseer-ul-Quran) in the native language of the user corresponding to an image of Arabic script system according to claim 4, in which each text block is processed as a separate query term and interlinked with internal and external data storage.

6. The real time information retrieval and augmented reality representation of the Quranic Citations and explanations of the Holy Quran (Tafseer-ul-Quran) in the native language of the user corresponding to an image of Arabic script system according to claim 5, in which said internal and external storage includes certified information, key references, original references with translations, and cross references, definitions and explanations.

7. The real time information retrieval and augmented reality representation of the Quranic Citations and explanations of the Holy Quran (Tafseer-ul-Quran) in the native language corresponding to an image of Arabic script system according to claim 6, in which said programmable computer upon finding a query term in data storage records each record containing the set of certified references with human translations, cross references and definitions with human translations described and explained in different native languages and selects the cited reference in the native language of the user and returns the information to the client user's device.

8. The real time information retrieval and augmented reality representation of the Quranic Citations and explanations of the Holy Quran (Tafseer-ul-Quran) in the native language of the user corresponding to an image of Arabic script system according to claim 7, in which the key information is displayed on the client/user device as augmented reality and with the links to detailed information is available for display/replay using default associated applications of the client user's device. Wherein the information available in a format of audio and video streaming are playable through default audio/video player of the client user's device.

9. The real time information retrieval and augmented reality representation of the Quranic Citations and explanations of the Holy Quran (Tafseer-ul-Quran) in the native language of the user corresponding to an image of Arabic script system according to claim 7, in which said memory includes a number of native languages and the certified copy of Holy Quran in Arabic script, human translated version of Holy Quran and explanations of the Holy Quran (Tafseer-ul-Quran) by Islamic Scholars are provided in each of said native languages.

10. The real time information retrieval and augmented reality representation of the Quranic Citations and explanations of the Holy Quran (Tafseer-ul-Quran) in the native language of the user corresponding to an image of Arabic script system according to claim 9, in which said device is a remote.

11. A system for real time information retrieval and augmented reality representation of the Quranic Citations and explanations of the Holy Quran (Tafseer-ul-Quran) in the native language of the user corresponding to an image of Arabic script, said system consisting of:
a programmable computer having memory and a copy of the Holy Quran in Arabic script and an explanation of the Holy Quran (Tafseer-ul-Quran) in said memory, and a native language translation of the Holy Quran and explanation of the Holy Quran (Tafseer-ul-Quran) in the native language of the user in said memory;
a device for inputting queries re: the Holy Quran to said programmable computer for receiving and displaying responses from said computer on said device;
said programmable computer performing operations of taking real time images and inputs through a user interface and segregating manuscript from images and marking manuscript characters and detecting native language of the user from default setting of the user interface;
initiating separate search queries using the text of each manuscript block as a query term to locate the blocks from interlinked internal and external data storage having certified information, references and explanations described in different native languages;
communicating with said user device with certified information in each segregated block; and
displaying the certified information as augmented reality.

12. A method for real time information retrieval and augmented reality representation of Quranic Citations and explanations of the Holy Quran (Tafseer-ul-Quran) in the native language of the user corresponding to an image of Arabic script, said method comprising:
providing a programmable computer having memory and a copy of the Holy Quran in Arabic script and an explanation of the Holy Quran (Tafseer-ul-Quran) in said memory, and a native language translation of the Holy Quran and explanation of the Holy Quran (Tafseer-ul-Quran) in the native language of the user in said memory;
providing a user's computational device:
using said computer, inputting queries re: the Holy Quran to said programmable computer for receiving and displaying responses from said computer on the user's computational device;
performing operations on said programmable computer of taking real time images and inputs through a user interface and segregating manuscript from images and marking manuscript characters and detecting native language of the user from default setting of the user interface;
initiating separate search queries using the text of each manuscript block as a query term to locate the blocks from interlinked internal and external data storage having certified information, references and explanations described in different native languages;
communicating with said user device with certified information in each segregated block; and
displaying the certified information as augmented reality on said user's device.

13. A method for real time information retrieval and augmented reality representation of Quranic Citations and explanations of the Holy Quran (Tafseer-ul-Quran) in the native language of the user corresponding to an image of Arabic script, said method consisting of:
providing a programmable computer having memory and a copy of the Holy Quran in Arabic script and an explanation of the Holy Quran (Tafseer-ul-Quran) in said memory, and a translation of the Holy Quran and explanation of the Holy Quran (Tafseer-ul-Quran) in the native language of the user in said memory;
providing a user's computational device:
using said computer, inputting queries re: the Holy Quran to said programmable computer for receiving and displaying responses from said computer on the user's computational device;
performing operations on said programmable computer of taking real time images and inputs through a user interface and segregating manuscript from images and marking manuscript characters and detecting native language of the user from default setting of the user interface;
initiating separate search queries using the text of each manuscript block as a query term to locate the blocks from interlinked internal and external data storage having certified information, references and explanations described in different native languages;
communicating with said user device with certified information in each segregated block; and
displaying the certified information as augmented reality on said user's device.

14. An apparatus for real time information retrieval and augmented reality representation of the Quranic Citations and explanations of the Holy Quran (Tafseer-ul-Quran) in the native language of the user corresponding to an image of Arabic script, said apparatus comprising:
a programmable computer having memory and a copy of the Holy Quran in Arabic script and an explanation of the Holy Quran (Tafseer-ul-Quran) in said memory, and a native language translation of the Holy Quran and explanation of the Holy Quran (Tafseer-ul-Quran) in the native language of the user from the Arabic script;
a device for inputting queries re: the Holy Quran to said programmable computer for receiving and displaying responses from said computer on said device;
said programmable computer performing operations of taking real time images and inputs through a user interface and segregating manuscript from images and marking manuscript characters and detecting native language of the user from default setting of the user interface;
initiating separate search queries using the text of each manuscript block as a query term to locate the blocks from interlink intervals and external data storage having certified information, references and explanations described in different native languages;
communicating with said user device with certified information in each segregated block; and
displaying the certified information as augmented reality; and
in which said memory includes a number of native languages and the certified copy of the Holy Quran in Arabic script, human translated version of Holy Quran and explanation of the Holy Quran (Tafseer-ul-Quran) by Islamic Scholars are provided in each of said native languages.

15. An apparatus for real time information retrieval and augmented reality representation of the Quranic Citations and explanations of the Holy Quran (Tafseer-ul-Quran) in the native language of the user corresponding to an image of Arabic script according to claim 14, in which said apparatus includes an auto focus mechanism to focus on real time image for readability and accuracy and wherein said user device is a remote unit.
